(19) United States
(12) Patent Application Publication
(10) Pub. No.: US 2020/0073327 A1
(43) Pub. Date: Mar. 5, 2020

(54) IMAGE FORMING APPARATUS

(71) Applicant: CANON KABUSHIKI KAISHA, Tokyo (JP)

(72) Inventor: Hideki Hayashi, Yoshikawa-shi (JP)

(21) Appl. No.: 16/537,766

(22) Filed: Aug. 12, 2019

(30) Foreign Application Priority Data
Aug. 31, 2018 (JP) 2018-163332

(51) Int. Cl. G03G 21/20; G03G 15/16; G03G 15/20

(52) U.S. Cl. CPC G03G 21/206; G03G 15/2028; G03G 15/161

(57) ABSTRACT

An image forming apparatus includes a transfer portion configured to transfer a toner image to a sheet, a fixing portion configured to fix the toner image, a conveyance guide pair configured to form a conveyance path through which the sheet onto which the toner image has been fixed by the fixing portion passes, a conveyance portion configured to convey the sheet on the conveyance path, an air blowing unit configured to blow air toward the conveyance path, and a control unit configured to control the conveyance portion and the air blowing unit, wherein the control unit is configured to execute a stop operation of controlling the conveyance portion to stop the sheet on the conveyance path, and to control a drive time of the air blowing unit during the stop operation in response to a stop time of the sheet in the stop operation.

### BACKGROUND OF THE INVENTION

### Field of the Invention

The present invention relates to an image forming apparatus configured to form a toner image on a sheet.

### Description of the Related Art

Hitherto, an image forming apparatus is known in which a toner image is transferred to a sheet in an image forming unit and the toner image is fixed to the sheet in a fixing device (refer to Japanese Patent Laid-Open Publication No. 2014-112256). According to this image forming apparatus, if an image is to be formed on both sides of the sheet, the sheet on which a toner image is formed on a first side is reversed, and then the sheet is guided to a duplex conveyance path. Thereafter, the sheet is guided again to the image forming unit, where a toner image is formed on a second side in the image forming unit.

Further according to the image forming apparatus disclosed in Japanese Patent Laid-Open Publication No. 2014-112256, a conveyance roller of the duplex conveyance path is controlled to stop the sheet near an exit of the duplex conveyance path to adjust the timing with the image or to keep a certain interval with a preceding sheet. Further according to the image forming apparatus, a fan is provided to blow air to the sheet that has come to a stop in the duplex conveyance path, and a stop time of the sheet is determined according to the type, size and thickness of the sheet. The image forming apparatus adjusts the conveyance speed and conveyance timing of the conveyance roller provided on the duplex conveyance path to ensure the determined stop time.

However, in the image forming apparatus disclosed in Japanese Patent Laid-Open Publication No. 2014-112256, if interrupt processing is entered while the sheet is stopped or if a long time is required in a postprocessing performed by a postprocessing apparatus, it was necessary to extend the stop time of the sheet in the duplex conveyance path. Since the fan keeps on blowing air to the sheet, the moisture content in the sheet is reduced too much if the stop time is long. Then, transfer failure may occur while transferring an image to the second side, and the image quality may be deteriorated.

### SUMMARY OF THE INVENTION

According to one aspect of the present invention, an image forming apparatus includes a transfer portion configured to transfer a toner image to a sheet, a fixing portion configured to fix the toner image transferred by the transfer portion to a sheet, a conveyance guide pair configured to form a conveyance path through which the sheet onto which the toner image has been fixed by the fixing portion passes, and to guide the sheet toward the transfer portion, a conveyance portion configured to convey the sheet on the conveyance path, an air blowing unit configured to blow air to the sheet in the conveyance path, and a control unit configured to control the conveyance portion and the air blowing unit, wherein the control unit is configured to execute a stop operation of controlling the conveyance portion to stop the sheet on the conveyance path, and to control the air blowing unit during the stop operation based on a stop time of the sheet in the stop operation.

Further features of the present invention will become apparent from the following description of exemplary embodiments with reference to the attached drawings.

### BRIEF DESCRIPTION OF THE DRAWINGS

FIG. 1 is an entire schematic diagram illustrating a printer according to a first embodiment.

FIG. 2 is a cross-sectional view illustrating a duplex conveyance unit.

FIG. 3 is a perspective view illustrating a conveyance guide pair.

FIG. 4 is a cross-sectional view illustrating an air blowing unit.

FIG. 5 is a control block diagram according to the first embodiment.

FIG. 6 is a cross-sectional view illustrating a sheet that has stopped at a stop position on the duplex conveyance path.

FIG. 7 is a graph illustrating a change of moisture content of sheet.

FIG. 8 is a flowchart illustrating control of a fan and a conveyance roller pair.

FIG. 9 is a flowchart illustrating a processing for determining a set time according to a second embodiment.

FIG. 10 is a flowchart illustrating a control of a fan and a conveyance roller pair according to a third embodiment.

FIG. 11 is a flowchart illustrating a processing for determining air volume of an air blowing unit according to another embodiment.

### DESCRIPTION OF THE EMBODIMENTS

### First Embodiment

### General Configuration

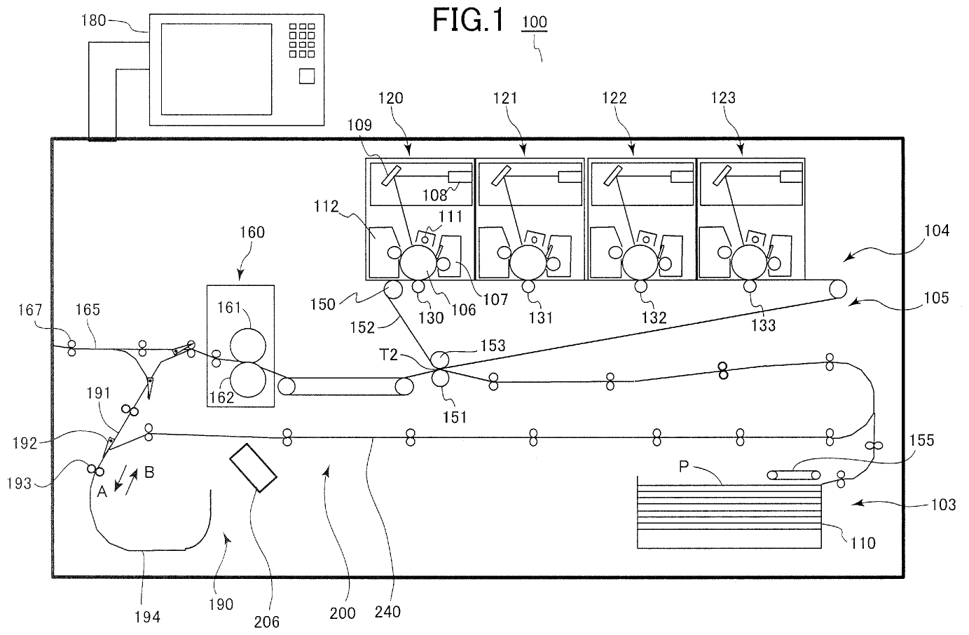

A first embodiment will be described. A printer 100 serving as an image forming apparatus is a full-color laser beam printer adopting an electrophotographic system. The printer 100 can use various types of sheets, such as normal paper which is used widely, recycled paper, glossy paper, coated paper, thin paper and thick paper. The printer 100 includes, as illustrated in FIG. 1, a sheet feed unit 103, an image forming unit 104, a fixing unit 160, a sheet discharge roller pair 167, a reverse conveyance unit 190, a duplex conveyance unit 200 and an operation unit 180. The operation unit 180 includes multiple physical keys and a liquid crystal panel, through which attribute information including size, type and grammage of the sheet P being used can be entered.

The image forming unit 104 includes four process units 120, 121, 122 and 123 for forming toner images of four colors, which are yellow (Y), magenta (M), cyan (C) and black (Bk), and an intermediate transfer unit 105. The four process units 120, 121, 122 and 123 have the same configuration, except for the difference in the color of the images being formed. Therefore, the configuration and image forming process of only the process unit 120 will be described, and descriptions of process units 121, 122 and 123 will be omitted.

The process unit 120 includes a photosensitive member 106 for bearing a toner image, a charging unit 111, a developing unit 112, a cleaning unit 107, a semiconductor laser 108, and a polygon mirror 109. The intermediate transfer unit 105 includes an intermediate transfer belt 152, and primary transfer rollers 130, 131, 132 and 133 arranged in an inner space surrounded by the intermediate transfer belt 152, the primary transfer rollers 130, 131, 132 and 133 arranged to oppose to respective photosensitive members of the process units 120, 121, 122 and 123. The intermediate transfer belt 152 rotates by a drive roller 150. The intermediate transfer unit 105 includes a secondary transfer roller 151 and a counter roller 153, and the secondary transfer roller 151 and the counter roller 153 together form a secondary transfer portion T2 serving as a transfer portion.

The fixing unit 160 serving as a fixing portion includes a heating roller 161 and a pressing roller 162 that apply predetermined heat and pressure to the sheet. The sheet feed unit 103 includes a cassette 110 storing sheets P, and a conveyance belt 155 that conveys the sheet P stored in the cassette 110.

Next, an image forming operation of the printer 100 configured as above will be described. When an image signal is entered to the semiconductor laser 108 from a personal computer and the like not shown, a laser beam corresponding to the image signal is irradiated on the photosensitive member 106 of the process unit 120 from the semiconductor laser 108.

In this state, the surface of the photosensitive member 106 is charged uniformly to predetermined polarity and potential by the charging unit 111, and by irradiating laser beams from the semiconductor laser 108 via a polygon mirror 109, an electrostatic latent image is formed on the surface thereof. The electrostatic latent image formed on the photosensitive member 106 is developed by the developing unit 112, and a yellow (Y) toner image is formed on the photosensitive member 106. Similarly, laser beams are irradiated from the semiconductor laser to respective photosensitive members of process units 121, 122 and 123, and toner images of magenta (M), cyan (C) and black (Bk) are formed on the respective photosensitive members.

These toner images are sequentially transferred to the intermediate transfer belt 152 in multilayers by having transfer bias voltage of positive polarity applied to the primary transfer rollers 130, 131, 132 and 133, and a full color toner image is formed on the intermediate transfer belt 152.

In parallel with the image forming process, the sheet P stored in the cassette 110 is fed by the conveyance belt 155 of the sheet feed unit 103. The sheet P is conveyed via a plurality of conveyance roller pairs toward the secondary transfer portion T2. The toner image borne on the intermediate transfer belt 152 is secondarily transferred to the sheet P at the secondary transfer portion T2 by having a transfer bias voltage of positive polarity applied to the secondary transfer roller 151. Thereby, a full color toner image is formed on the surface of the sheet P.

The sheet P to which the toner image has been transferred is subjected to predetermined heat and pressure by the fixing unit 160, by which the toner image is fixed to the sheet P. The sheet P to which the toner image has been fixed passes through a sheet discharge conveyance path 165 and is discharged to the exterior of the device by the sheet discharge roller pair 167.

In the case of a duplex printing job in which images are formed on both sides of the sheet P, the sheet P passes the fixing unit 160 before being guided to the reverse conveyance unit 190. Then, the sheet P is reversed at the reverse conveyance unit 190 and guided again to the secondary transfer portion T2 through a duplex conveyance path 240 of the duplex conveyance unit 200. A toner image is formed on a back side of the sheet P at the secondary transfer portion T2, and the sheet P is discharged to the exterior of the device by the sheet discharge roller pair 167. The sheet P being discharged to the exterior of the device by the sheet discharge roller pair 167 can be received by a sheet processing apparatus not shown connected to the printer 100 or can be stacked on a sheet discharge tray not shown provided on the printer 100.

### Reverse Conveyance Unit

Next, the reverse conveyance unit 190 will be described in detail. The reverse conveyance unit 190 includes a reverse conveyance path 191, a guide member 192, a reverse roller pair 193, and a reverse guide 194. The guide member 192 is disposed at a branching portion between the reverse conveyance path 191 and the duplex conveyance path 240, and it pivots to switch conveyance destinations of the sheet P being reversed by the reversed roller pair 193.

The reverse roller pair 193 serving as a reverse conveyance portion is configured to be able to rotate in normal and reverse directions and to perform a reverse conveyance operation in which the sheet P is conveyed to a first direction A and thereafter conveyed to a second direction B that is opposite to the first direction A.

The reverse guide 194 is arranged downstream of the reverse roller pair 193 in the first direction A, and the reverse guide 194 is capable of guiding the sheet P in during reverse conveyance operation. In this state, the reverse guide 194 slides against a side of the sheet P on which the toner image has been transferred at the secondary transfer portion T2, hereinafter referred to as transfer side.

That is, the sheet P conveyed in the first direction A by the reverse roller pair 193 is guided while sliding against the reverse guide 194. When a trailing edge of the sheet P passes the guide member 192, the guide member 192 pivots and the reverse roller pair 193 rotates in the reverse direction. Thereby, the sheet P is conveyed in the second direction B and guided by the guide member 192 to the duplex conveyance path 240 serving as a conveyance path.

### Duplex Conveyance Unit

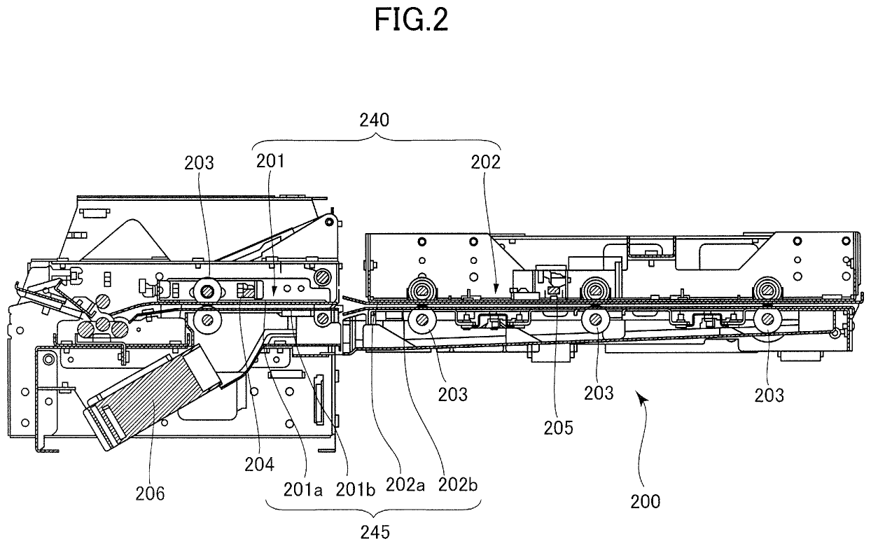

Next, the duplex conveyance unit 200 will be described in detail. As illustrated in FIG. 2, the duplex conveyance unit 200 includes an upstream path 201 formed by an upstream upper guide 201a and an upstream lower guide 201b, and a downstream path 202 formed by a downstream upper guide 202a and a downstream lower guide 202b. The downstream path 202 is arranged downstream of the upstream path 201 in the sheet conveyance direction. The upstream path 201 and the downstream path 202 constitute the duplex conveyance path 240, and the upstream upper guide 201a, the upstream lower guide 201b, the downstream upper guide 202a and the downstream lower guide 202b constitute a conveyance guide pair 245 that forms the duplex conveyance path 240.

Further, the duplex conveyance unit 200 includes a plurality of conveyance roller pairs 203 serving as a conveyance portion for conveying the sheet on the duplex conveyance path 240, and sheet detection sensors 204 and 205 that respectively detect the position of the sheet passing through the upstream path 201 and the downstream path 202. The respective sheet detection sensors 204 and 205 are composed of a flag member that pivots by being pressed by the sheet, and a photosensor that detects pivoting of the flag member. The respective sheet detection sensors 204 and 205 can also be composed of a light emitting portion that irradiates light toward the sheet being conveyed, and a photosensing portion that receives reflected light from the sheet.

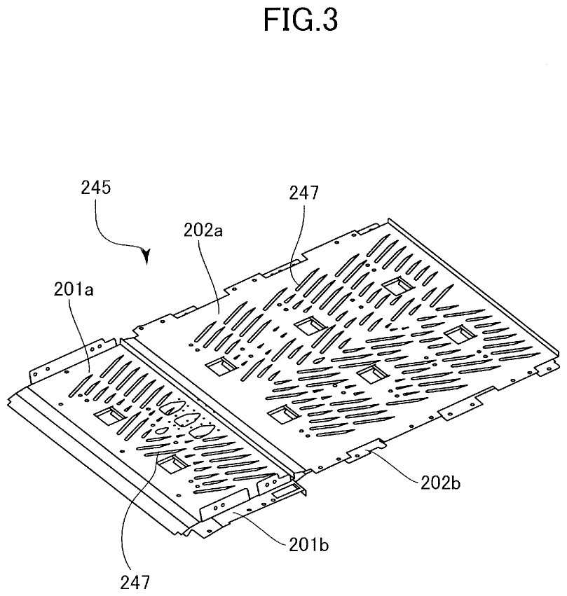

As illustrated in FIG. 3, a plurality of holes 247 are respectively formed on the upstream upper guide 201a, the upstream lower guide 201b, the downstream upper guide 202a and the downstream lower guide 202b constituting the conveyance guide pair 245. The holes 247 enable air sent from an air blowing unit 260 described later to pass therethrough. In the present embodiment, the plurality of holes 247 are formed on each of the upstream upper guide 201a, the upstream lower guide 201b, the downstream upper guide 202a and the downstream lower guide 202b constituting the conveyance guide pair 245, but the present invention is not limited thereto. For example, the plurality of holes 247 should be formed at least on either the upstream upper guide 201a or the upstream lower guide 201b. For example, the plurality of holes 247 should be formed at least on either the downstream upper guide 202a or the downstream lower guide 202b.

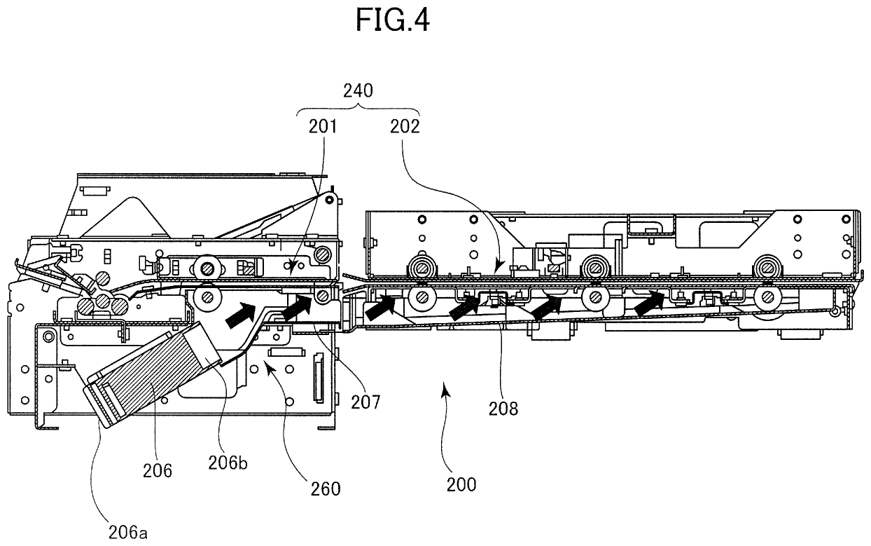

Further, as illustrated in FIG. 4, the duplex conveyance unit 200 includes an air blowing unit 260 that blows air toward the duplex conveyance path 240. The air blowing unit 260 is composed of a fan 206 and ducts 207 and 208, wherein the fan 206 rotates to intake air from an air inlet port 206a and blow out air through an air outlet port 206b. The fan 206 is arranged upstream of the sheet detection sensors 204 and 205 in the sheet conveyance direction. The air inlet port 206a is arranged near the reverse guide 194 of the reverse conveyance unit 190, and the air outlet port 206b is connected to the duct 207.

The air blown from the fan 206 is sent through the duct 207 toward the upstream path 201. The duct 207 is also connected to the duct 208, and a part of the wind blowing through the duct 207 is sent through the duct 208 toward the downstream path 202. As described, the air blown to the duplex conveyance path 240 composed of the upstream path 201 and the downstream path 202 is sent through the ducts 207 and 208, the holes 247 and the duplex conveyance path 240 to the interior of the printer 100.

Generally, water vapor is released from the sheet heated by the fixing unit 160 by moisture contained in the sheet being evaporated. The water vapor is cooled at the conveyance guide pair 245 (refer to FIG. 2) and dew condensation may be generated in the conveyance guide pair 245. By having dew condensation as water drops adhere to the sheet P, image defects or jamming of sheets caused by the sheet P sticking on the conveyance guide pair 245 may occur.

However, according to the present embodiment, the air blow generated by the air blowing unit 260 passes through the duplex conveyance path 240 and is sent to the interior of the printer 100. Therefore, water vapor released from the sheet P is prevented from accumulating in the duplex conveyance path 240, and generation of dew condensation in the conveyance guide pair 245 can be reduced. Thereby, image defects and occurrence of sheet jamming can be reduced.

Further, the sheet P conveyed in the duplex conveyance path 240 is cooled by the air blown from the air blowing unit 260 to the duplex conveyance path 240. If the sheet P is discharged to the exterior of the printer 100 while the sheet is still hot, the toner on the surface of the discharged sheet may re-melt and the image quality may be deteriorated, or the discharged sheets may stick together. Further, if the temperature of the sheet P is increased, toner is heated and softened, by which frictional force between the conveyance guide and the sheet is increased. Thereby, the sheet P may be buckled and conveyance failure may occur.

As described, the air blown from the air blowing unit 260 has a function to cool the temperature of the sheet and to reduce dew condensation. The fan 206 will exert better efficiency against dew condensation if it is provided on an upstream side in the sheet conveyance direction of the duplex conveyance path 240, since air can be blown to a wider area in the duplex conveyance path 240.

### Control Block

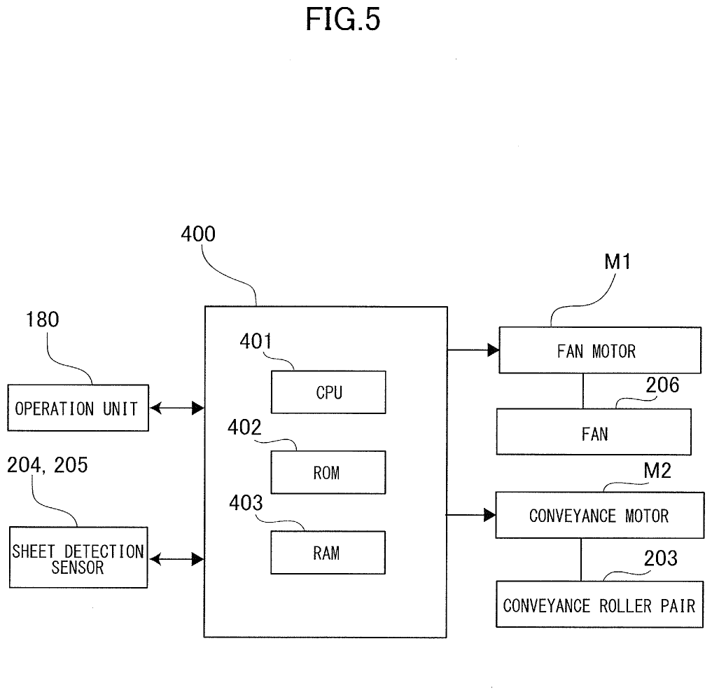

FIG. 5 is a control block diagram of the present embodiment. As illustrated in FIG. 5, the printer 100 (refer to FIG. 1) includes a control unit 400, and the control unit 400 includes a CPU 401, a ROM 402 that stores programs, and a RAM 403 that is used as an execution area of programs. The operation unit 180, the sheet detection sensors 204 and 205, a fan motor M1 and a conveyance motor M2 are connected to the control unit 400. The fan motor M1 drives the fan 206. The conveyance motor M2 drives the plurality of conveyance roller pairs 203 arranged on the duplex conveyance path 240.

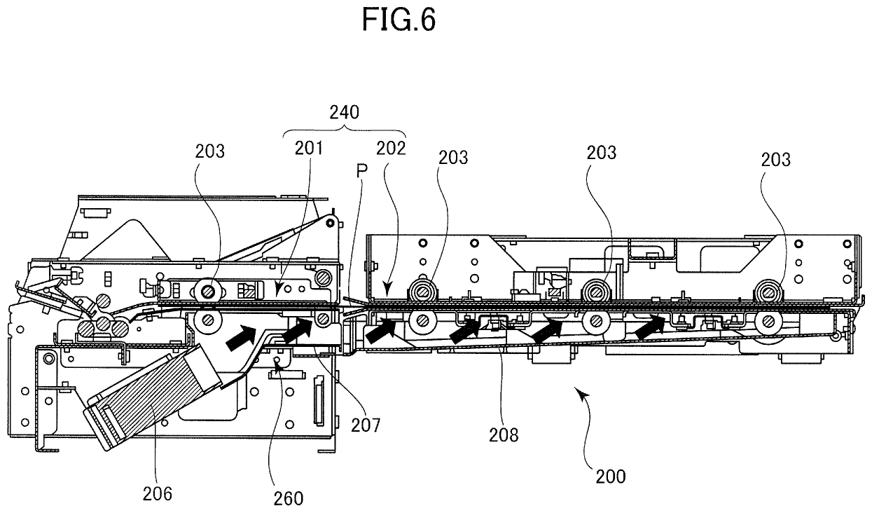

In the case of the duplex printing job, the control unit 400 is capable of executing stop operation where the sheet P is stopped at a predetermined stop position on the duplex conveyance path 240 by stopping the conveyance motor M2, as illustrated in FIG. 6. For example, the sheet P is stopped at the predetermined stop position based on the detection result of the sheet detection sensors 204 and 205 serving as sensors. Then, if a conveyance permission signal permitting conveyance of the sheet P is entered, the control unit 400 drives the conveyance motor M2, the sheet P is conveyed by the secondary transfer portion T2, and an image is formed on the second side at the secondary transfer portion T2. The sheet P is stopped at the stop position on the duplex conveyance path 240 to adjust the timing with the image formed in the image forming unit 104 or to maintain a sheet interval with a preceding sheet. If the conveyance permission signal is already entered when the sheet P reaches the stop position on the duplex conveyance path 240, the sheet P does not have to be stopped in midway.

The air blowing unit 260 is arranged so that the air blown from the air blowing unit 260 blows against the sheet P stopped by the stop operation. Thereby, the sheet P can be cooled efficiently. Moreover, since the ducts 207 and 208 allow the air blown from the fan 206 to spread in the sheet conveyance direction and a width direction orthogonal to the sheet conveyance direction, the sheet P can be cooled efficiently. The ducts 207 and 208 are arranged so that they are overlapped in the sheet conveyance direction with the sheet stopped at the stop position.

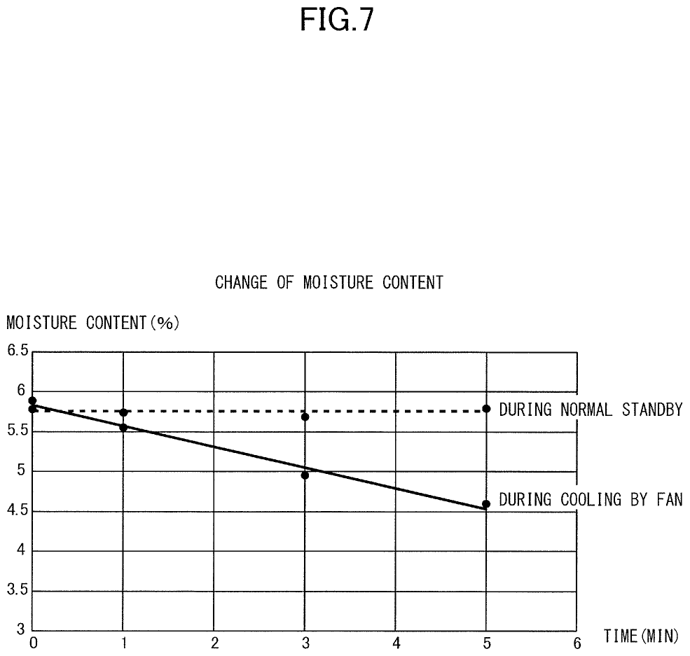

FIG. 7 is a graph illustrating a relationship between a time during which the sheet P stopped at the stop position receives air blow from the air blowing unit 260 and a moisture content of the sheet P. As illustrated by the broken line of FIG. 7, in a state where the sheet P is stopped at the stop position without driving the fan 206, the moisture content of the sheet P is slightly reduced with elapse of time. In contrast, if wind is blown to the sheet P in the stopped state by driving the fan 206, it can be recognized that the moisture content of the sheet P is reduced greatly as the time during which the sheet P receives air blow extends. If the moisture content of the sheet P becomes too little, transfer failure may occur during image transfer at the second transfer portion T2, and image quality may be deteriorated.

### Control of Fan and Conveyance Roller Pair

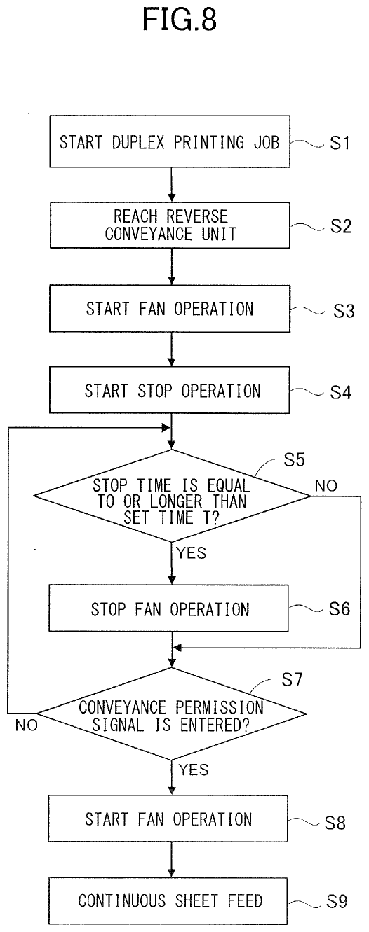

Next, control of the fan 206 and the conveyance roller pair 230 according to the present embodiment will be described with reference to the flowchart of FIG. 8. As illustrated in FIG. 8, if a duplex printing job is started (step S1), a sheet P is fed from the sheet feed unit 103, and a toner image is transferred to a first side of the sheet P at the secondary transfer portion T2. In this state, the fan 206 is stopped. Then, the sheet P passes the fixing unit 160 and reaches the reverse conveyance unit 190 (step S2).

In a state where the sheet P reaches the reverse conveyance unit 190, the control unit 400 drives the fan motor M1 and starts operation of the fan 206 (step S3). As described, the fan 206 is started after the sheet P reaches the reverse conveyance unit 190, so that noise while printing can be reduced. Thereafter, reverse conveyance operation is performed by the reverse roller pair 193, and the sheet P is guided to the duplex conveyance path 240. The control unit 400 controls the plurality of conveyance roller pairs 203 through the conveyance motor M2 and starts stop operation where the sheet P is stopped at the stop position on the duplex conveyance path 240 (step S4).

Stop time of the sheet P during stop operation differs according to product model, operating condition of the printer and so on, but if an interrupt processing is entered during sheet stop or if postprocessing performed in the postprocessing device takes much time, the stop time of the sheet becomes especially long. For example, there is a printer having multiple cassettes 110, and the printer is controlled to feed sheets from a second cassette if there is no more sheet stored in a first cassette during printing job of multiple sheets. In an operation to switch cassettes serving as feed source of sheets, a cleaning process of cleaning the image formed on the image forming unit must be performed, so that stop time of the sheet P is extended.

Further, if postprocessing performed by the sheet processing apparatus not shown connected to the printer 100 takes much time, the stop time of a subsequent sheet P in the duplex conveyance path 240 becomes long to ensure sheet interval with the preceding sheet. If the stop time of the sheet P is long, the sheet P may receive air from the air blowing unit 260 for a long period of time, and the moisture content of the sheet P may become too little so that transfer failure may occur.

Therefore, according to the present embodiment, stop time of the sheet P is detected by the sheet detection sensors 204 and 205, and the control unit 400 determines whether the stop time of the sheet P is equal to or longer than a set time T serving as a predetermined time (step S5). If the stop time of the sheet P is shorter than a set time T (step S5: NO), the procedure advances to step S7. If the stop time of the sheet P is equal to or longer than the set time T (step S5: YES), the control unit 400 stops the fan motor M1 and stops the operation of the fan 206 (step S6). That is, the control unit 400 decreases an air blowing capacity of the fan 206 in a case where the stop time exceeds a predetermined time.

Next, the control unit 400 determines whether conveyance permission signal to permit conveyance of the sheet P has been entered (step S7). If the conveyance permission signal has not been entered (step S7: NO), the procedure returns to step S5. If the conveyance permission signal has been entered (step S7: YES), the control unit 400 ends the stop operation, and drives the conveyance motor M2 to resume conveyance of the sheet P by the conveyance roller pairs 203. Further, the control unit 400 drives the fan motor M1 and starts operation of the fan 206 (step S8). Thereafter, the control unit 400 performs continuous sheet feed of the subsequent sheet P in a similar manner (step S9).

As described, according to the present embodiment, the operation of the fan 206 is stopped if the stop time of the sheet P during stop operation is equal to or longer than a set time T. That is, the control unit 400 controls the fan 206 not to blow air more than a predetermined period to the sheet P stopped by the stop operation. Thereby, even if the stop time of the sheet P is relatively long, the moisture content of the sheet P will not become too little, so that occurrence of transfer failure can be reduced and image quality can be improved. That is, based on the stop time of the sheet P, drive time of the air blowing unit 260 during stop operation can be controlled.

If the moisture content of the sheet P is maintained appropriately, the driving and stopping of the air blowing unit 260 can be repeatedly performed from start of stop operation until input of the conveyance permission signal. In other words, the total time during which the sheet P during stop operation receives air blow from the air blowing unit 260 should be within an appropriate range. Further, if stop time of the sheet P can be computed in advance, there is no need to detect the stop time of the sheet P by the sheet detection sensors 204 and 205.

### Second Embodiment

Next, a second embodiment of the present invention will be described, wherein the second embodiment has added a control to determine a set time T to the first embodiment. Therefore, similar configurations as the first embodiment are either not shown or denoted with the same reference numbers.

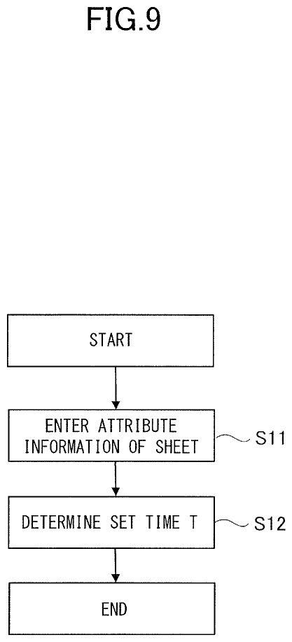

Generally, moisture of the sheet tends to be removed easily by air in a sheet having a low grammage compared to a sheet having a high grammage. Further, removal of moisture of the sheets differ among sheet types, such as between coated paper and noncoated paper. Therefore, in the present embodiment, a control to determine set time T is performed, as illustrated in FIG. 9.

At first, the user enters attribute information including size, type and grammage of the sheet P being used through the operation unit 180 (step S11). The entered attribute information is stored in the RAM 403, for example. The control unit 400 determines the set time T based on the entered attribute information of the sheet P (step S12). For example, if the grammage of the sheet P being conveyed is a first grammage, the set time T is set to a first period of time, and if the grammage of the sheet P is a second grammage that is smaller than the first grammage, the set time T is set to a second period of time that is shorter than the first period of time. Thereafter, when a duplex printing job is entered, various processes illustrated in FIG. 8 are performed, by which the moisture content of the sheet P can be maintained more appropriately based on the attribute information of the sheet.

### Third Embodiment

Next, a third embodiment of the present invention will be described. The third embodiment only differs from the first embodiment in the control of the fan 206. Therefore, similar configurations as the first embodiment are either not shown or denoted with the same reference numbers.

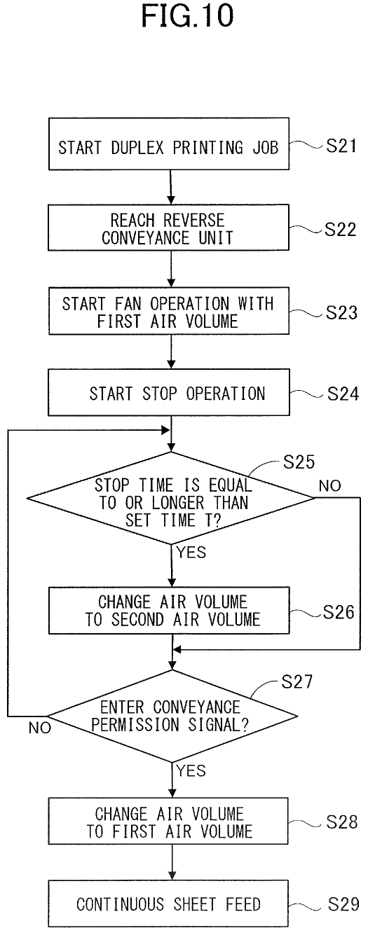

The control of the fan 206 and the conveyance roller pair 230 according to the present embodiment will be described with reference to the flowchart of FIG. 10. The steps S21, S22, S24, S25, S27 and S29 according to FIG. 10 is the same as steps S1, S2, S4, S5, S7 and S9 of the first embodiment (refer to FIG. 8), so descriptions thereof are omitted.

In a state where the sheet P reaches the reverse conveyance unit 190 (step S22), the control unit 400 drives the fan motor M1 and starts operating the fan 206 so that an air volume of the fan 206 is set to a first air volume (step S23). For example, by increasing the current supplied to the fan motor M1, the rotational speed of the fan 206 is increased and the air volume is increased. Further, by reducing the current supplied to the fan motor M1, the rotational speed of the fan 206 is reduced and the air volume of the fan 206 is reduced. The air volume output from the fan 206 can also be varied by providing a shutter to the air outlet port 206b of the fan 206 and opening or closing the shutter to change the opening area of the air outlet port 206b.

Thereafter, the sheet P is subjected to reverse conveyance operation by the reverse roller pair 193 and guided to the duplex conveyance path 240. The control unit 400 controls the plurality of conveyance roller pairs 203 through the conveyance motor M2 and starts the stop operation where the sheet P is stopped at the stop position on the duplex conveyance path 240 (step S24). The stop time of the sheet P is detected by the sheet detection sensors 204 and 205, and the control unit 400 determines whether the stop time of the sheet P is equal to or longer than the set time T (step S25). If the stop time of the sheet P is smaller than the set time T (step S25: NO), the procedure advances to step S27. If the stop time of the sheet P is equal to or longer than the set time T (step S25: YES), the control unit 400 decelerates the fan motor M1 and changes the air volume of the fan 206 to a second air volume that is smaller than the first air volume (step S26). That is, the control unit 400 decreases an air blowing capacity of the fan 206 in a case where the stop time exceeds a predetermined time.

Next, the control unit 400 determines whether a conveyance permission signal that permits conveyance of the sheet P has been entered (step S27). If the conveyance permission signal has not been entered (step S27: NO), the procedure returns to step S25. If the conveyance permission signal has been entered (step S27: YES), the control unit 400 drives the conveyance motor M2 and resumes conveyance of the sheet P by the conveyance roller pairs 203. Further, the control unit 400 increases the speed of the fan motor M1 and changes the air volume of the fan 206 to the first air volume (step S28). Thereafter, the control unit 400 performs continuous sheet feed of the subsequent sheet P in a similar manner (step S29).

As described, according to the present embodiment, if stop time of the sheet P in stop operation is equal to or longer than the set time T, the air volume of the fan 206 is changed to the second air volume that is smaller than the first air volume. Thereby, even if the stop time of the sheet P is relatively long, the moisture content of the sheet P will not be reduced too much, so that occurrence of transfer failure can be reduced and image quality can be improved. That is, the air volume of the air blowing unit 260 during stop operation is controlled based on the stop time of the sheet P.

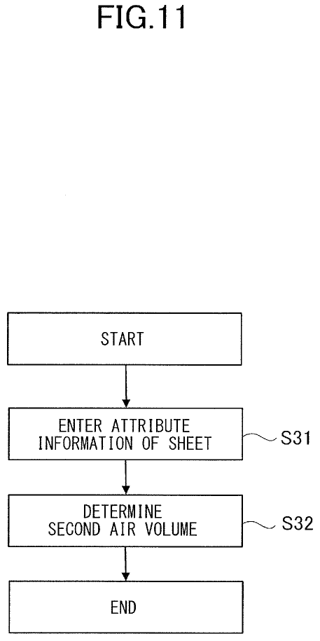

As long as the moisture content of the sheet P is maintained appropriately, the air volume of the air blowing unit 260 can be varied many times after stop operation has been started and before the conveyance permission signal is entered. Further, as illustrated in FIG. 11, the control unit 400 can perform an air volume determination control for determining the second air volume based on attribute information of the sheet entered through the operation unit 180. In other words, as illustrated in FIG. 11, the user enters the attribute information such as the size, type and grammage of the sheet P being used through the operation unit 180 (step S31). The attribute information being entered is stored in the RAM 403, for example. Then, based on the attribute information of the sheet P being entered, the control unit 400 determines the second air volume (step S32). For example, if the grammage of the sheet P being conveyed is the first grammage, the second air volume is set to a first value, and if the grammage of the sheet P is the second grammage that is smaller than the first grammage, the second air volume is set to a second value that is smaller than the first value. Further, not only the second air volume but the first air volume can be determined arbitrarily based on the attribute information of the sheet.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-163332, filed Aug. 31, 2018, which is hereby incorporated by reference herein in its entirety.

What is claimed is:

1. An image forming apparatus comprising:
a transfer portion configured to transfer a toner image to a sheet;
a fixing portion configured to fix the toner image transferred by the transfer portion to a sheet;
a conveyance guide pair configured to form a conveyance path through which the sheet onto which the toner image has been fixed by the fixing portion passes, and to guide the sheet toward the transfer portion;
a conveyance portion configured to convey the sheet on the conveyance path;
an air blowing unit configured to blow air to the sheet in the conveyance path; and
a control unit configured to control the conveyance portion and the air blowing unit,
wherein the control unit is configured to execute a stop operation of controlling the conveyance portion to stop the sheet on the conveyance path, and to control the air blowing unit based on a stop time of the sheet in the stop operation.

2. The image forming apparatus according to claim 1, wherein the control unit decrease an air blowing capacity of the air blowing unit in a case where the stop time exceeds a predetermined time.

3. The image forming apparatus according to claim 1, wherein the control unit controls a drive time of the air blowing unit during the stop operation based on the stop time.

4. The image forming apparatus according to claim 3, wherein the control unit controls the air blowing unit not to blow air more than a predetermined period to the sheet stopped by the stop operation.

5. The image forming apparatus according to claim 3, wherein the control unit stops air blow by the air blowing unit in a case where the stop time exceeds a predetermined time.

6. The image forming apparatus according to claim 3, wherein the control unit is configured to resume air blow by the air blowing unit in a state where the stop operation is ended and conveyance of sheet by the conveyance portion is resumed.

7. The image forming apparatus according to claim 5, wherein the control unit is configured to set up the predetermined time based on attribute information of the sheet being conveyed.

8. The image forming apparatus according to claim 5, wherein the control unit is configured to set the predetermined time to a first period of time in a state where grammage of the sheet being conveyed is a first grammage, and set the predetermined time to a second period of time that is shorter than the first period of time in a state where the grammage of the sheet being conveyed is a second grammage that is smaller than the first grammage.

9. The image forming apparatus according to claim 1, wherein the control unit controls an air volume of the air blowing unit during the stop operation based on the stop time.

10. The image forming apparatus according to claim 9, wherein the control unit is configured to start air blow with a first air volume by the air blowing unit prior to the stop operation, and to control the air blowing unit to blow air with a second air volume that is smaller than the first air volume in a case where the stop time exceeds a predetermined time.

11. The image forming apparatus according to claim 10, wherein the control unit is configured to control the air blowing unit to blow air with the first air volume in a state where the stop operation is ended and conveyance of sheet by the conveyance portion is resumed.

12. The image forming apparatus according to claim 10, wherein the control unit is configured to control the second air volume based on attribute information of the sheet being conveyed.

13. The image forming apparatus according to claim 10, wherein the control unit sets the second air volume to a first value in a state where grammage of the sheet being conveyed is a first grammage, and sets the second air volume to a second value that is smaller than the first value in a state where the grammage of the sheet being conveyed is a second grammage that is smaller than the first grammage.

14. The image forming apparatus according to claim 9, wherein the air blowing unit comprises a fan configured to rotate and generate air, and a duct configured to guide the air generated by the fan to the conveyance path, and
the control unit is configured to control the air volume of the air blowing unit by changing a rotational speed of the fan.

15. The image forming apparatus according to claim 1, further comprising a reverse conveyance portion configured to perform a reverse conveyance operation in which the sheet onto which the toner image has been fixed is conveyed to a first direction and thereafter conveyed to a second direction that is opposite to the first direction, and
wherein the sheet subjected to the reverse conveyance operation passes through the conveyance path formed by the conveyance guide pair.

16. The image forming apparatus according to claim 1, wherein at least one conveyance guide of the conveyance guide pair comprises a hole through which air blown from the air blowing unit passes.

17. The image forming apparatus according to claim 1, wherein the air blowing unit comprises a fan configured to rotate and generate air, and a duct configured to guide the air generated by the fan to the conveyance path.

18. The image forming apparatus according to claim 1, wherein the air blowing unit is arranged so that air sent from the air blowing unit blows against the sheet stopped by the stop operation.

19. The image forming apparatus according to claim 1, further comprising a sensor configured to detect a position of the sheet conveyed on the conveyance path,
wherein in the stop operation, the control unit is configured to stop the sheet at a stop position on the conveyance path based on a detection result of the sensor,
the air blowing unit comprises a fan that is arranged upstream of the sensor in a sheet conveyance direction and that is configured to rotate and generate air, and a duct that is arranged to overlap the sheet stopped at the stop position in the sheet conveyance direction and that is configured to guide the air generated by the fan to the sheet stopped at the stop position, and
at least one conveyance guide of the conveyance guide pair has a hole through which air passed through the duct passes.
